(19) United States
(12) Patent Application Publication
(10) Pub. No.: US 2005/0106034 A1
(43) Pub. Date: May 19, 2005

(54) Heat insulating structure of compressor

(76) Inventors: Fuminobu Enokijima, Kariya-shi (JP); Masakazu Murase, Kariya-shi (JP); Tatsuya Koide, Kariya-shi (JP); Masaki Ota, Kariya-shi (JP)

Correspondence Address: Morgan & Finnegan, L.L.P., 3 World Financial Center, New York, NY, 10281-2101, US

(21) Appl. No.: 10/991,156

(22) Filed: Nov. 17, 2004

(30) Foreign Application Priority Data
Nov. 17, 2003 (JP) 2003-387206

(51) Int. Cl. F03C 2/00; F04C 2/00

(52) U.S. Cl. 417/269; 417/313; 417/521

(57) ABSTRACT

A compressor has a suction chamber and a discharge chamber, and compresses refrigerant gas. The compressor includes a cover housing having an inner wall surface. The inner wall surface defines at least one of the suction chamber and the discharge chamber. A heat insulating member covers the inner wall surface. A flow restraining member restrains refrigerant gas from flowing between the heat insulating member and the inner wall surface. Hence, the adiabatic efficiency increases in at least one of the suction chamber and the discharge chamber within the compressor.

### BACKGROUND OF THE INVENTION

The present invention relates to heat insulating structure of a compressor equipped with a cover housing with a suction chamber or a discharge chamber.

Temperature of refrigerant gas introduced into a suction chamber within a compressor from the outside of the compressor affects performance of the compressor. Since as the temperature of the refrigerant gas introduced into the suction chamber rises, density of the refrigerant gas to be sucked into a compression chamber decreases, and thus the performance of the compressor will be degraded.

In a compressor disclosed in Japanese National Phase Laid-Open Patent Publication No. 2001-515174, in an inner wall of a housing cover defining the suction chamber, there is laid heat insulating material. The heat insulating material laid in the inner wall defining the suction chamber contributes to overheat prevention of the refrigerant gas within the suction chamber.

Since the heat insulating material laid in the inner wall defining the suction chamber has loosely been inserted in the suction chamber, there are clearances between the inner wall and the heat insulating material. For this reason, part of the refrigerant gas is sucked into the compression chamber through these clearances. The refrigerant gas that has flowed through the clearances between the inner wall and the heat insulating material will be heated by heat transferred from the inner wall, and the refrigerant gas heated by the inner wall will be sucked into the compression chamber. This will degrade the adiabatic efficiency, and this degraded adiabatic efficiency will degrade the performance of the compressor.

### SUMMARY OF THE INVENTION

An object of the present invention is to increase the adiabatic efficiency in at least one of the suction chamber and the discharge chamber within the compressor.

To achieve the above-mentioned objective, the present invention provides a compressor that has a suction chamber and a discharge chamber, and compresses refrigerant gas. The compressor includes a cover housing having an inner wall surface. The inner wall surface defines at least one of the suction chamber and the discharge chamber. A heat insulating member covers the inner wall surface. A flow restraining member restrains refrigerant gas from flowing between the heat insulating member and the inner wall surface.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a side cross-sectional view showing an entire compressor for a first embodiment embodying the present invention;

FIG. 2 is a cross-sectional view taken on line A-A of FIG. 1;

FIG. 3 is a cross-sectional view taken on line B-B of FIG. 1;

FIG. 4 is an essential enlarged side cross-sectional view showing the compressor of FIG. 1;

FIG. 5 is an exploded perspective view showing the compressor of FIG. 1;

FIG. 6 is an essential side cross-sectional view showing a second embodiment according to the present invention;

FIG. 7 is an essential side cross-sectional view showing a third embodiment according to the present invention;

FIG. 8 is an essential side cross-sectional view showing a fourth embodiment according to the present invention;

FIG. 9 is an essential side cross-sectional view showing a fifth embodiment according to the present invention;

FIG. 10 is an essential side cross-sectional view showing a sixth embodiment according to the present invention; and

FIG. 11 is an essential side cross-sectional view showing a seventh embodiment according to the present invention;

### DETAILED DESCRIPTION OF THE PREFERRED EMBODIMENTS

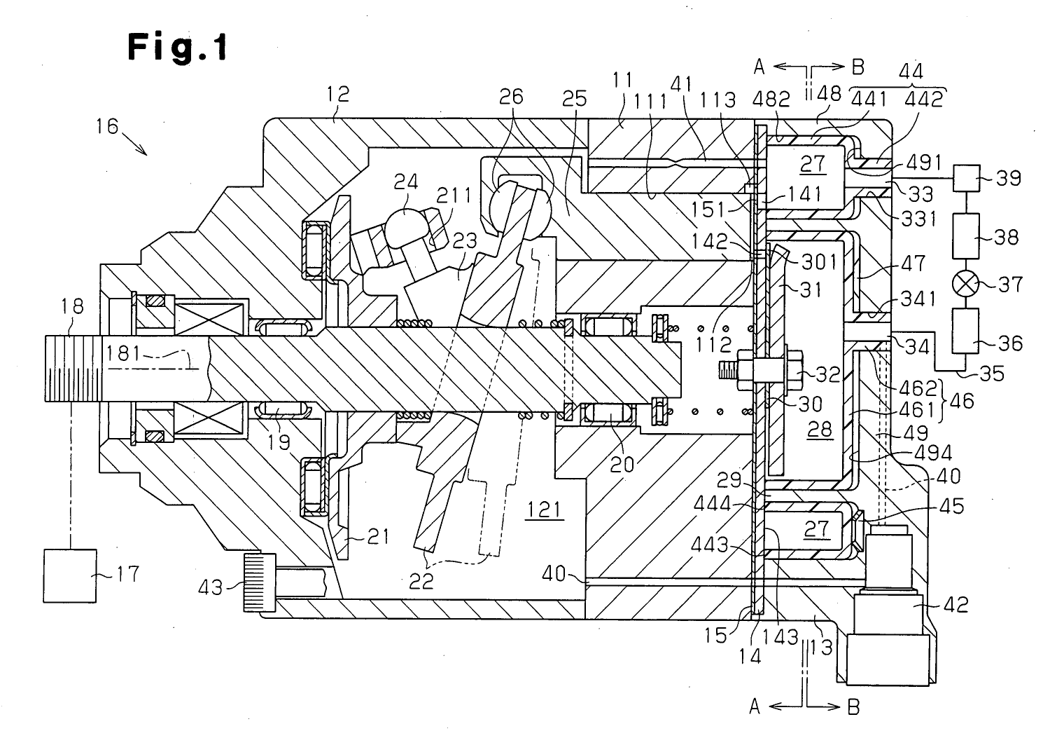

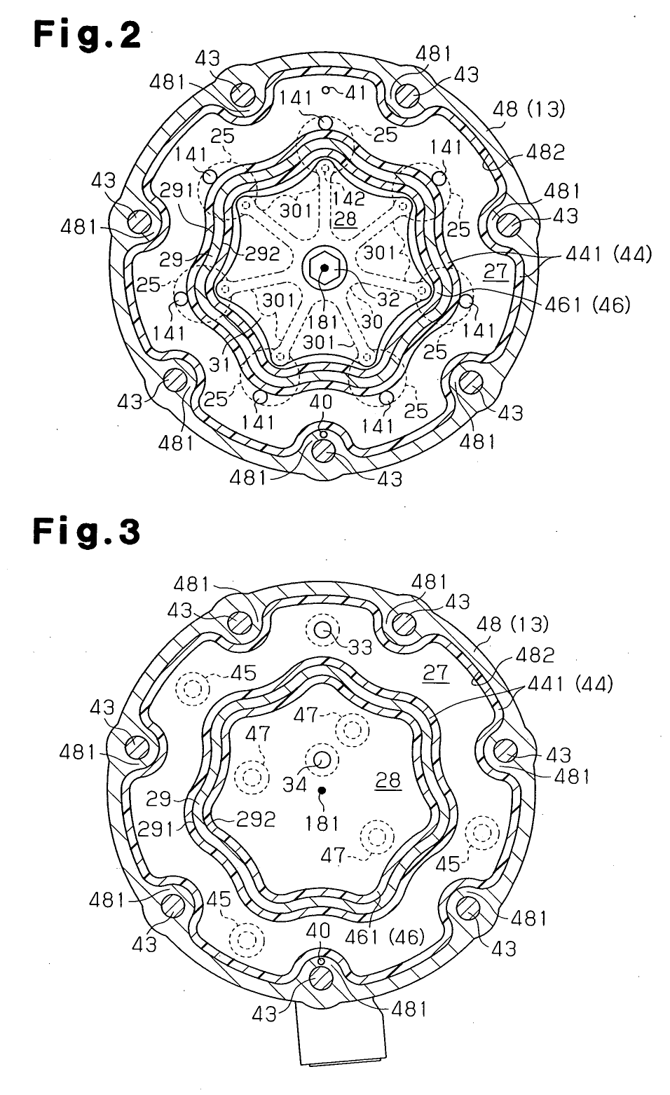

Hereinafter, with reference to FIGS. 1 to 5, the description will be made of the first embodiment embodying the present invention.

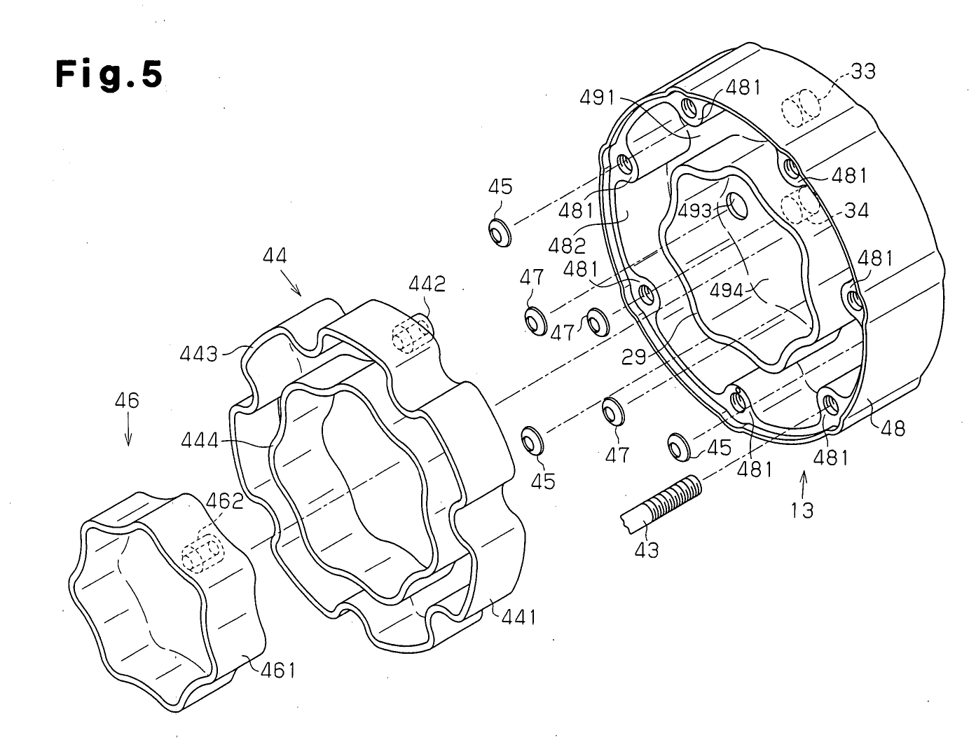

As shown in FIG. 1, a piston type variable displacement compressor 16 has a cylinder 11. A front housing member 12 made of aluminum is joined to the front end of the cylinder 11 made of aluminum. To the rear end of the cylinder 11, a rear housing member 13 made of aluminum as a cover housing is joined and fixed via a valve plate 14 and a valve formation plate 15. The cylinder 11, the front housing member 12 and the rear housing member 13 are jointly fastened by a screw 43. As shown in FIG. 5, a plurality of nut portions 481 are formed at the outer peripheral wall 48 of the rear housing member 13. A screw 43 is threadedly engaged with the nut portion 481. The cylinder 11, the front housing member 12 and the rear housing member 13 constitute the entire housing of the compressor 16.

As shown in FIG. 1, in the front housing member 12 and the cylinder 11, which form a control pressure chamber 121, a rotating shaft 18 is rotationally supported via radial bearings 19, 20. The rotating shaft 18 for protruding outward from the control pressure chamber 121 acquires a driving force from a vehicle engine 17, which is an external driving force, via a pulley (not shown) and a belt (not shown).

At the rotating shaft 18, a lug plate 21 is fixedly provided, and a swash plate 22 is supported in an axial direction of the rotating shaft 18 slidably and in such a manner as to be obliquely movable. At the swash plate 22, a coupling piece 23 is fixedly provided, and at the coupling piece 23, a guide pin 24 is fixedly provided. A guide hole 211 is formed at the lug plate 21. The head portion of the guide pin 24 is slidably fitted in the guide hole 211. The swash plate 22 is capable of obliquely moving in the axial direction of the rotating shaft 18 and rotating integrally with the rotating shaft 18 by the link-up of the guide hole 211 with the guide pin 24. The oblique motion of the swash plate 22 is guided by slide guide relationship between the guide hole 211 and the guide pin 24, and slide supporting by the rotating shaft 18.

When the central portion of the swash plate 22 moves toward the lug plate 21, an inclined angle of the swash plate 22 increases. A maximum inclined angle of the swash plate 22 is regulated by abutting between the lug plate 21 and the swash plate 22. A solid line position of the swash plate 22 of FIG. 1 shows a maximum inclined angle state of the swash plate 22. When the central portion of the swash plate 22 moves toward the cylinder 11, the inclined angle of the swash plate 22 decreases. A chain line position of the swash plate 22 of FIG. 1 shows a minimum inclined angle state of the swash plate 22.

Within a plurality of cylinder bores 111 piercingly provided in the cylinder 11, pistons 25 are accommodated. A rotary motion of the swash plate 22 is converted into longitudinal reciprocating motion of the piston 25 via shoes 26, and the piston 25 is reciprocally driven within the cylinder bore 111. The piston 25 partitions a compression chamber 112 within the cylinder bore 111.

As shown in FIGS. 1, 2 and 3, within the rear housing member 13, a suction chamber 27, which constitutes part of a suction pressure domain, and a discharge chamber 28, which constitutes part of a discharge pressure domain, are partitioned by an annular partition wall 29. The suction chamber 27 is on the outer periphery side of the rear housing member 13, and surrounds the discharge chamber 28 around the axis line 181 of the rotating shaft 18. As shown in FIG. 1, within the discharge chamber 28, to the valve plate 14, the valve formation plate 30 and a retainer 31 are combined by fastening a screw 32.

As shown in FIG. 1, the valve plate 14 and the valve formation plate 15 are formed with a suction port 141 and a discharge port 142. The valve formation plate 15 is formed with a suction valve 151, and the valve formation plate 30 is formed with a discharge valve 301. Gaseous refrigerant within the suction chamber 27 is sucked into the compression chamber 112 through the suction port 141 with the suction valve 151 pushed aside by a returning operation (movement from the right to the left in FIG. 1) of the piston 25. The suction valve 151 is opening-regulated by abutting on the bottom of a position regulating concave portion 113. The gaseous refrigerant sucked into the compression chamber 112 is discharged into a discharge chamber 28 through the discharge port 142 with a discharge valve 301 pushed aside by a going operation (movement from the left to the right in FIG. 1) of the piston 25. The discharge valve 301 is opening-regulated by abutting on the retainer 31.

On the end wall 49 of the rear housing member 13, a suction passage 33, which constitutes part of a suction pressure domain, and a discharge passage 34, which constitutes part of a discharge pressure domain are formed. The suction passage 33 for introducing gaseous refrigerant into the suction chamber 27 and the discharge passage 34 for discharging gaseous refrigerant from the discharge chamber 28 are connected together through an external refrigerant circuit 35. On the external refrigerant circuit 35, a heat exchanger 36 for taking heat from the refrigerant, a fixed restrictor 37, a heat exchanger 38 for transferring surrounding heat to the refrigerant, and an accumulator 39 are interposed. The accumulator 39 sends only gaseous refrigerant to the compressor. The refrigerant in the discharge chamber 28 flows into the suction chamber 27 via the discharge passage 34, the heat exchanger 36, the fixed restrictor 37, the heat exchanger 38, the accumulator 39 and the suction passage 33.

The discharge chamber 28 and the control pressure chamber 121 are connected together through a supply passage 40 via the discharge passage 34. The control pressure chamber 121 and the suction chamber 27 are connected together through an expelling passage 41. The refrigerant within the control pressure chamber 121 flows out into the suction chamber 27 via the expelling passage 41.

On the supply passage 40, an electromagnetic displacement control valve 42 is interposed. The displacement control valve 42 is in a valve-closed state in which the refrigerant cannot circulate in an excited state, and no refrigerant is supplied from the discharge chamber 28 into the control pressure chamber 121 via the supply passage 40. Since the refrigerant within the control pressure chamber 121 flows out into the suction chamber 27 via the expelling passage 41, the pressure within the control pressure chamber 121 falls. Therefore, the inclined angle of the swash plate 22 increases and the displacement increases. The displacement control valve 42 enters a valve-opened state in which the refrigerant can circulate by means of demagnetization, and the refrigerant is supplied from the discharge chamber 28 into the control pressure chamber 121 via the supply passage 40. Therefore, the pressure within the control pressure chamber 121 rises, the inclined angle of the swash plate 22 decreases and the displacement decreases.

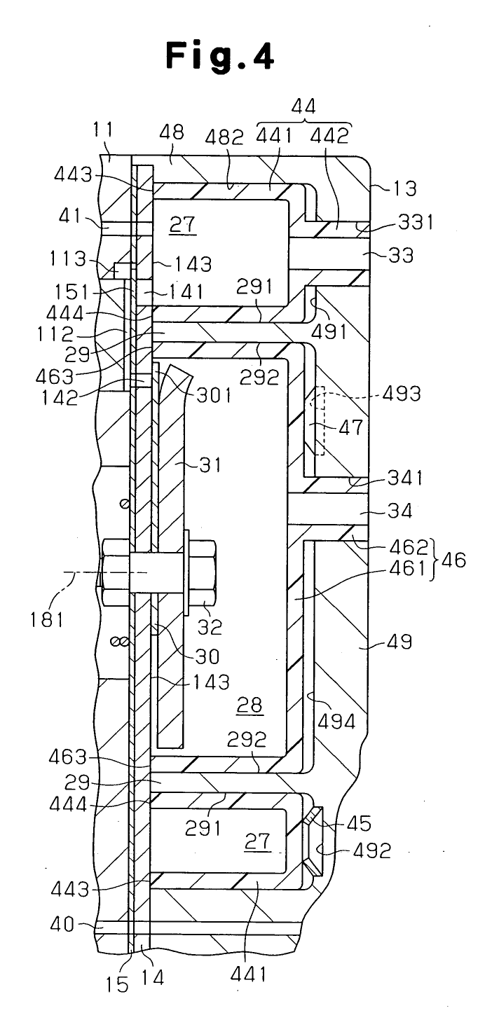

As shown in FIG. 4, in the suction chamber 27, a heat insulating member 44 has loosely been inserted. The heat insulating member 44 is composed of: a chamber heat insulating member 441, with which the inner wall surface 482 of an outer peripheral wall 48, the inner wall surface 491 of the end wall 49 and the outer peripheral wall surface 291 of a partition wall 29 are covered; and a passage heat insulating member 442 for covering a peripheral wall surface 331 for defining the suction passage 33. In other words, the heat insulating member 44 covers the inner wall surface (inner wall surfaces 482, 491, outer peripheral wall surface 291 and peripheral wall surface 331) on the suction chamber 27 side in the rear housing member 13 for defining the suction chamber 27 and the suction passage 33. A surface 143 of the valve plate 14 for facing the suction chamber 27 forms a part of a defining wall surface of the suction chamber 27.

Between the end wall 49 of the rear housing member 13 and the chamber heat insulating member 441, a plurality of coned disk springs 45 are interposed. In the present embodiment, three coned disk springs 45 are used as shown in FIG. 5. The coned disk spring 45 is accommodated within a concave portion 492 formed on the inner wall surface 491 of the end wall 49. The coned disk spring 45 urges the heat insulating member 44 toward the valve plate 14. An end edge 443, 444 of the chamber heat insulating member 441 is pressed against the valve plate 14 by a spring operation of the coned disk spring 45, and between the end edge 443, 444 and the valve plate 14, there occurs no clearance. The coned disk spring 45 is a pressing-against member (a flow restraining member) for restraining refrigerant gas from flowing between the heat insulating member 44 and the inner wall surface (inner wall surfaces 482, 491, outer peripheral wall surface 291 and peripheral wall surface 331) on the suction chamber 27 side in the rear housing member 13 by pressing the heat insulating member 44 against the defining wall surface (surface 143) of the suction chamber 27.

As shown in FIG. 4, in the discharge chamber 28, the heat insulating member 46 has loosely been inserted. The heat insulating member 46 is composed of: a chamber heat insulating member 461, with which the inner wall surface 494 of the end wall 49 and the inner peripheral wall surface 292 of a partition wall 29 are covered; and a passage heat insulating member 462 for covering a peripheral wall surface 341 for defining the discharge passage 34. In other words, the heat insulating member 46 covers the inner wall surface (inner wall surface 494, inner peripheral wall surface 292 and peripheral wall surface 341) on the discharge chamber 28 side in the rear housing member 13 for defining the discharge chamber 28 and the discharge passage 34. A surface 143 of the valve plate 14 for facing the discharge chamber 28 forms a part of a defining wall surface of the discharge chamber 28.

Between the end wall 49 of the rear housing member 13 and the chamber heat insulating member 461, a plurality of coned disk springs 47 are interposed. In the present embodiment, three coned disk springs 47 are used as shown in FIG. 5. The coned disk spring 47 is accommodated within a concave portion 493 formed on the inner wall surface 494 of the end wall 49. The coned disk spring 47 urges the heat insulating member 46 toward the valve plate 14. An end edge 463 of the chamber heat insulating member 461 is pressed against the valve plate 14 by a spring operation of the coned disk spring 47, and between the end edge 463 and the valve plate 14, there occurs no clearance. The coned disk spring 47 is a pressing-against member (flow restraining member) for restraining refrigerant gas from flowing between the heat insulating member 46 and the inner wall surface (inner wall surfaces 494, inner peripheral wall surface 292 and peripheral wall surface 341) on the discharge chamber 28 side in the rear housing member 13 by pressing the heat insulating member 46 against the defining wall surface (surface 143) of the discharge chamber 28.

In the present embodiment, the heat insulating member 44, 46 is made of synthetic resin. For the refrigerant, carbon dioxide has been used.

The first embodiment has the following advantages.

(1-1) In association with the operation of the piston type variable displacement compressor 16, the temperature becomes high within the discharge chamber 28 and within the discharge passage 34 in which there exists compressed refrigerant gas, and temperature of the rear housing member 13 rises. The heat insulating member 44 for covering the inner wall surface (inner wall surfaces 482, 491, outer peripheral wall surface 291 and peripheral wall surface 331) on the suction chamber 27 side in the rear housing member 13 is made of synthetic resin having low thermal conductivity. The heat insulating member 44 reduces heat transfer from the rear housing member 13 made of aluminum having high thermal conductivity to the refrigerant gas within the suction chamber 27 and the suction passage 33.

Since the heat insulating member 44 has loosely been inserted in the suction chamber 27, there are clearances between each of the outer peripheral wall 48, the end wall 49 and the partition wall 29 and the heat insulating member 44. If the refrigerant gas is sucked into the compression chamber 112 through these clearances, the refrigerant gas to which heat from the outer peripheral wall 48, the end wall 49 and the partition wall 29 has directly been transferred may be sucked into the compression chamber 112.

The end edge 443, 444 of the chamber heat insulating member 441 has been brought into tight-contact with the valve plate 14 by the spring operation of the coned disk spring 45. For this reason, there is no possibility that any refrigerant gas flows from the clearances between each of the outer peripheral wall 48, the end wall 49 and the partition wall 29 and the heat insulating member 44 via between the end edges 443, 444 and the valve plate 14. In other words, the operation of pressing the end edges 443, 444 against the valve plate 14 by means of the coned disk spring 45 restrains refrigerant gas from flowing between the inner wall surface (inner wall surfaces 482, 491, outer peripheral wall surface 291 and peripheral wall surface 331) of the rear housing member 13 for defining the suction chamber 27 and the suction passage 33 and the heat insulating member 44. As a result, an amount of heat to be directly transferred to the refrigerant gas from the rear housing member 13 is reduced, and adiabatic efficiency in the suction chamber 27 and the suction passage 33 within the compressor 16 is increased. This contributes to the improved performance of the compressor 16.

(1-2) The heat insulating member 46 made of synthetic resin for covering the inner wall surface (inner wall surfaces 494, inner peripheral wall surface 292 and peripheral wall surface 341) on the discharge chamber 28 side in the rear housing member 13 reduces heat transfer to the rear housing member 13 from the refrigerant gas within the discharge chamber 28 and the discharge passage 34. The reduced heat transfer to the rear housing member 13 from the refrigerant gas within the discharge chamber 28 and the discharge passage 34 leads to restraint of heat transfer to the refrigerant gas within the suction chamber 27 and the suction passage 33 from the rear housing member 13.

Since the heat insulating member 46 has loosely been inserted in the discharge chamber 28, between each of the partition wall 29 and the end wall 49 and the heat insulating member 46, there occur clearances. If the refrigerant gas passes through these clearances, the heat may be directly transferred from the refrigerant gas to the partition wall 29 and the end wall 49.

The end edge 463 of the chamber heat insulating member 461 has been brought into tight-contact with the valve plate 14 by the spring operation of the coned disk spring 47. For this reason, there is no possibility that any refrigerant gas flows from between the end edge 463 and the valve plate 14 via the clearances between each of the end wall 49 and the partition wall 29 and the heat insulating member 46. In other words, the operation of pressing the end edge 463 against the valve plate 14 by means of the coned disk spring 47 restrains the refrigerant gas from flowing between the inner wall surface (inner wall surfaces 494, inner peripheral wall surface 292 and peripheral wall surface 341) of the rear housing member 13 for defining the discharge chamber 28 and the discharge passage 34 and the heat insulating member 46.

As a result, an amount of heat to be directly transferred from the refrigerant gas discharged into the discharge chamber 28 to the rear housing member 13 is reduced, and adiabatic efficiency in the discharge chamber 28 and the discharge passage 34 within the compressor 16 is increased. This contributes to the improved performance of the compressor 16. Since the lowered temperature of the refrigerant gas within the discharge chamber 28 is restrained by the heat insulating member 46, the performance of the compressor 16 when applied to, for example, a heater in which the refrigerant gas within the discharge chamber 28 is used as a heat source will be improved.

(1-3) The heat insulating member 44 has loosely been inserted in the suction chamber 27. With such structure, there is no need for causing a shape of the inner wall surface (inner wall surface 482, 491 and outer peripheral wall surface 291) of the rear housing member 13 for defining the suction chamber 27 to strictly coincide with a shape of the chamber heat insulating member 441. There is no need for causing a shape of the inner wall surface (peripheral wall surface 331) of the rear housing member 13 for defining the suction passage 33 to strictly coincide with a shape of passage heat insulating member 442. This allows a large installation error between the rear housing member 13 and the heat insulating member 44, and it will facilitate machining and formation of the suction chamber 27 and the heat insulating member 44.

(1-4) The heat insulating member 46 has loosely been inserted in the discharge chamber 28. With such structure, there is no need for causing a shape of the inner wall surface (inner wall surface 494, and inner peripheral wall surface 292) of the rear housing member 13 for defining the discharge chamber 28 to strictly coincide with a shape of the chamber heat insulating member 461. There is no need for causing a shape of the inner wall surface (peripheral wall surface 341) of the rear housing member 13 for defining the discharge passage 34 to strictly coincide with a shape of passage heat insulating member 462. This allows a large installation error between the rear housing member 13 and the heat insulating member 46, and it will facilitate machining and formation of the discharge chamber 28 and the heat insulating member 46.

(1-5) The suction chamber 27 is located on the outer periphery side of the rear housing member 13, and the discharge chamber 28 is surrounded by the suction chamber 27 around the axis line 181 of the rotating shaft 18. The structure in which the suction chamber 27 has been provided on the outer periphery side (side close to the atmosphere) of the rear housing member 13 is preferable for restraint of heating the refrigerant gas within the suction chamber 27.

(1-6) Carbon dioxide, which is used as refrigerant in a higher pressure state than chlorofluorocarbon, requires a small amount of gas flow rate. As the gas flow rate decreases, prevention of heating of the refrigerant gas in the suction chamber 27 and the suction passage 33 is more important. The compressor 16 for using carbon dioxide as refrigerant is suitable for an object to which the present invention is applied.

(1-7) The coned disk spring 45, 47, which brings a great elastic force by a small elastic change, is suitable as a member for pressing the heat insulating member 44, 46 against the valve plate 14.

(1-8) The heat insulating member 44, 46 made of synthetic resin and the rear housing member 13 made of aluminum are different in coefficient of thermal expansion. Since, however, the heat insulating member 44, 46 has not been fixedly provided on the inner wall surface of the rear housing member 13, there is not any fear of any tensile load exerting on the heat insulating member 44, 46 by means of a difference in coefficient of thermal expansion. Therefore, the durability of the heat insulating member 44, 46 is excellent.

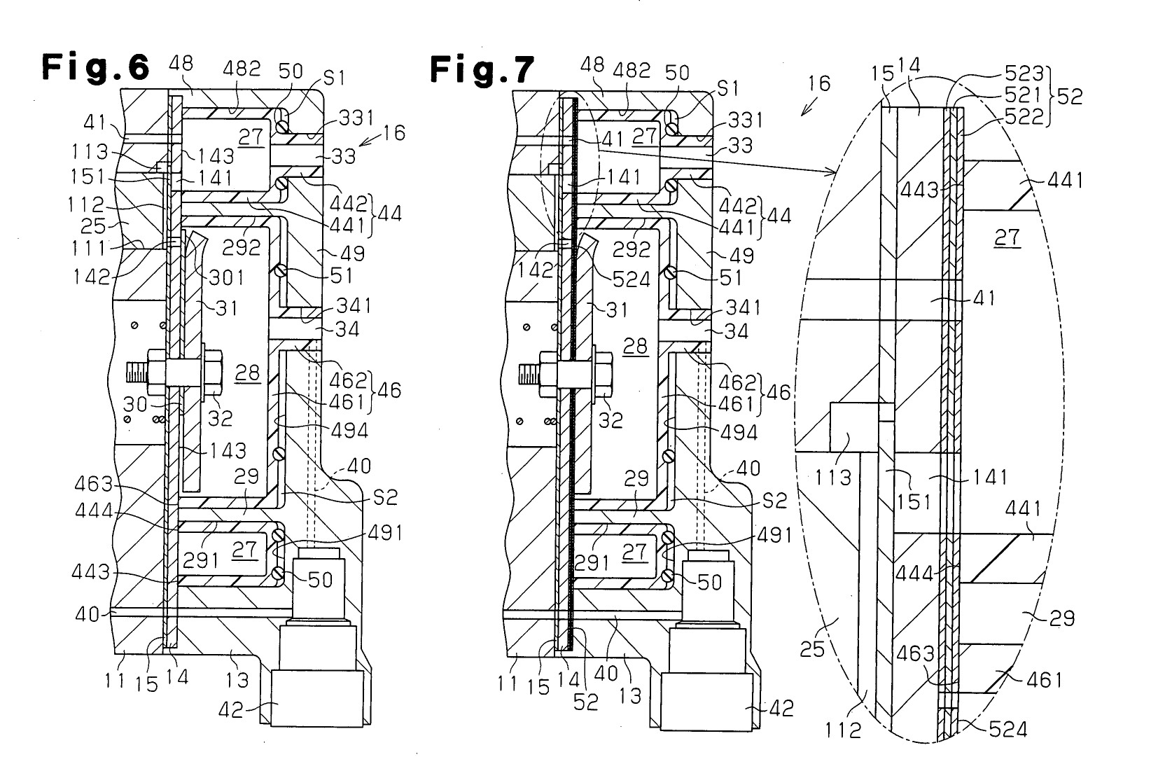

According to the present invention, each embodiment of FIGS. 6 to 11 is also possible. In each embodiment of FIGS. 6 to 11, components identical to those in the first embodiment are designated by the identical reference numbers.

In a second embodiment of FIG. 6, between the heat insulating member 44 and the inner wall surface 491 of the end wall 49 of the rear housing member 13, there are interposed a plurality of seal rings (seal members) 50 made of rubber. One of these is disposed to surround the passage heat insulating member 442.

Between the heat insulating member 46 and the inner wall surface 494 of the end wall 49, there is interposed a seal ring (seal member) 51. The seal ring 51 is disposed to surround the passage heat insulating member 462. The end edge 443, 444 of the chamber heat insulating member 441 is brought into tight-contact with the valve plate 14 by the operation of elastic deformation of a plurality of seal rings 50. An end edge 463 of a chamber heat insulating member 461 is brought into tight-contact with the valve plate 14 by the operation of elastic deformation of the seal ring 51.

The seal ring 50 is a flow restraining member for restraining the refrigerant gas from flowing between the heat insulating member 44 and the inner wall surface (inner wall surface 482, 491, outer peripheral wall surface 291 and peripheral wall surface 331) of the rear housing member 13 by the sealing operation. The seal ring 50 is a pressing-against member for restraining the refrigerant gas from flowing between the heat insulating member 44 and the inner wall surface (inner wall surface 482, 491, outer peripheral wall surface 291 and peripheral wall surface 331) of the rear housing member 13 by pressing the heat insulating member 44 against the defining wall surface (surface 143) of the suction chamber 27. In other words, the seal ring 50 is a flow restraining member for blockading the inner wall surface (inner wall surface 482, 491 and outer peripheral wall surface 291) of the rear housing member 13 from the suction passage 33 continuing to the inner wall surface (inner wall surface 482, 491 and outer peripheral wall surface 291) of the rear housing member 13 to be covered with the heat insulating member 44 over to the valve plate 14.

In other words, the heat insulating member 44 is loosely inserted in the suction chamber 27 so that a clearance is created between the inner wall surface (inner wall surface 482, 491 and outer peripheral wall surface 291) and the heat insulating member 44. The clearance expands to the valve plate 14 from the suction passage 33. The seal ring 50 blocks the clearance between the valve plate 14 and the suction passage 33. The seal ring 50 provided between the heat insulating member 44 and the inner wall surface 491 of the end wall 49 to surround the passage heat insulating member 442 forms space S1 blockaded between the chamber heat insulating member 441 and the inner wall surface 482, 491.

The seal ring 51 is a flow restraining member for restraining the refrigerant gas from flowing between the heat insulating member 46 and the inner wall surface (inner wall surface 494, inner peripheral wall surface 292 and peripheral wall surface 341) of the rear housing member 13 by the sealing operation. The seal ring 51 is a pressing-against member for restraining the refrigerant gas from flowing between the heat insulating member 46 and the inner wall surface (inner wall surface 494, inner peripheral wall surface 292 and peripheral wall surface 341) of the rear housing member 13 by pressing the heat insulating member 46 against the defining wall surface (surface 143) of the discharge chamber 28. In other words, the seal ring 51 is a flow restraining member for blockading the inner wall surface (inner wall surface 494, and inner peripheral wall surface 292) of the rear housing member 13 from the discharge passage 34 continuing to the inner wall surface (inner wall surface 494, and inner peripheral wall surface 292) of the rear housing member 13 to be covered with the heat insulating member 46 over to the valve plate 14.

In other words, the heat insulating member 46 is loosely inserted in the discharge chamber 28 so that a clearance is created between the inner wall surface (inner wall surface 494, and inner peripheral wall surface 292) and the heat insulating member 46. The clearance expands to the valve plate 14 from the discharge passage 34. The seal ring 51 blocks the clearance between the valve plate 14 and the discharge passage 34. The seal ring 51 provided between the heat insulating member 46 and the inner wall surface 494 of the end wall 49 forms space S2 blockaded between the chamber heat insulating member 461 and the inner peripheral wall surface 292.

The second embodiment has, in addition to similar advantages to term (1-1) to term (1-6) of the first embodiment, the following advantages.

The seal ring 50 for surrounding the passage heat insulating member 442 reliably cuts off a gas flow reaching from the clearances between the passage heat insulating member 442 and the peripheral wall surface 331 of the suction passage 33 to the clearances between the chamber heat insulating member 441 and the inner wall surface 491 of the end wall 49. Therefore, the existence of the seal ring 50 for surrounding the passage heat insulating member 442 further increases the adiabatic efficiency in the suction chamber 27 and the suction passage 33 more than in the first embodiment.

The seal ring 51 reliably obstructs a gas flow reaching from the clearances between the chamber heat insulating member 461 and the inner peripheral wall surface 292 of the partition wall 29 to the clearances between the passage heat insulating member 462 and the peripheral wall surface 341 of the discharge passage 34. Therefore, the existence of the seal ring 51 for surrounding the passage heat insulating member 462 further increases the adiabatic efficiency in the discharge chamber 28 and the discharge passage 34 more than in the first embodiment case.

Further, the existence of the blockaded space S1 contributes to restraint of heat transfer between the chamber heat insulating member 441 (heat insulating member 44) and each of the inner wall surface 482, 491 and the outer peripheral wall surface 291 to raise the adiabatic effect in the suction chamber 27. Similarly, the existence of the blockaded space S2 contributes to restraint of heat transfer between the chamber heat insulating member 461 (heat insulating member 46) and each of the inner wall surface 494 and the inner peripheral wall surface 292 to raise the adiabatic effect in the discharge chamber 28.

In a third embodiment of FIG. 7, between the valve plate 14 and the rear housing member 13, there is interposed a gasket 52. On both surfaces of a metallic plate 521 of the gasket 52, there have been provided rubber layers 522, 523. The gasket 52 is formed with a discharge valve 524. The end edge 443, 444, 463 of the heat insulating member 44, 46 is brought into tight contact with the rubber layer 522 of the gasket 52 by the operation of elastic deformation of the seal ring 50, 51.

The rubber layer 522, 523 restrains heat transfer from the valve plate 14 to the refrigerant gas within the suction chamber 27 and within the discharge chamber 28, and the rubber layer 522 contributes to the improved sealability between the gasket 52 and the end edge 443, 444, 463. The gasket 52 is separate from the valve plate 14, and is a coating member made of heat insulating material, for covering a surface 143 facing the rear housing member 13 (cover housing) in the valve plate 14. The existence of the gasket 52, which is such a coating member, further increases the adiabatic efficiency more than in the second embodiment of FIG. 6.

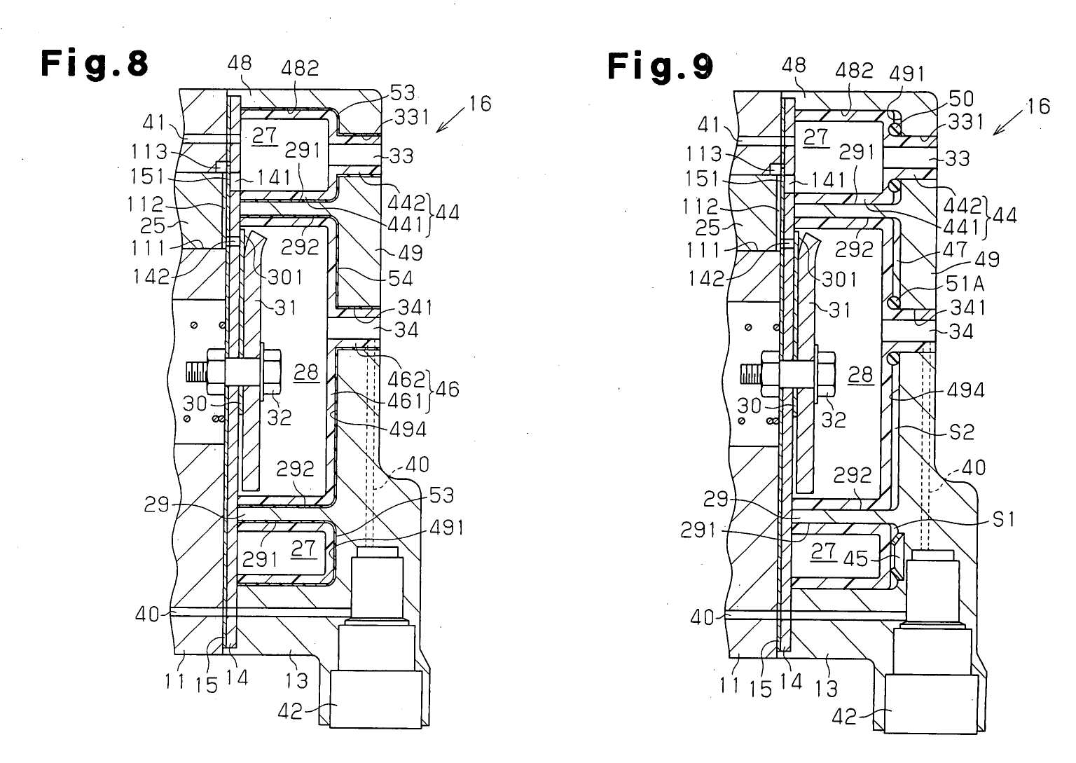

In a fourth embodiment of FIG. 8, the heat insulating member 44 has been glued to the inner wall surface 491, 482, the outer peripheral wall surface 291 and the peripheral wall surface 331 by a glue layer 53. The glue layer 53 is a gluing member for restraining the refrigerant gas from flowing between the heat insulating member 44 and the inner wall surface (inner wall surface 491, 482, outer peripheral wall surface 291 and peripheral wall surface 331) of the rear housing member 13 by gluing the heat insulating member 44 to the inner wall surface (inner wall surface 491, 482, outer peripheral wall surface 291 and peripheral wall surface 331) of the rear housing member 13. The glue layer 53 is a flow restraining member for blockading the inner wall surface on the suction chamber 27 from the suction passage 33 continuing to the inner wall surface (inner wall surface 482, 491, outer peripheral wall surface 291 and peripheral wall surface 331) on the suction chamber 27 in the rear housing member 13 to be covered by the heat insulating member 44 over to the valve plate 14.

The heat insulating member 46 has been glued to the inner wall surface 494, the inner peripheral wall surface 292 and the peripheral wall surface 341 by a glue layer 54. The glue layer 54 is a gluing member for restraining the refrigerant gas from flowing between the heat insulating member 46 and the inner wall surface of the rear housing member 13 by gluing the heat insulating member 46 to the inner wall surface (inner wall surface 494, inner peripheral wall surface 292 and peripheral wall surface 341) of the rear housing member 13. The glue layer 54 is a flow restraining member for blockading the inner wall surface on the discharge chamber 28 from the discharge passage 34 continuing to the inner wall surface (inner wall surface 494, inner peripheral wall surface 292 and peripheral wall surface 341) on the discharge chamber 28 in the rear housing member 13 to be covered by the heat insulating member 46 over to the valve plate 14.

Since between the heat insulating member 44 and the inner wall surface (inner wall surface 491, 482, outer peripheral wall surface 291 and peripheral wall surface 331) of the rear housing member 13, there occur no clearances, there is no possibility that the refrigerant gas enters between the heat insulating member 44 and the inner wall surface (inner wall surface 491, 482, outer peripheral wall surface 291 and peripheral wall surface 331) of the rear housing member 13. Therefore, heat in a portion of the inner wall surface (inner wall surface 491, 482, outer peripheral wall surface 291 and peripheral wall surface 331) of the rear housing member 13 to be covered with the heat insulating member 44 is not directly transferred to the refrigerant gas. Hence, the adiabatic efficiency in the suction chamber 27 and the suction passage 33 is at least high to the same extent as in the third embodiment of FIG. 7.

Similarly, since between the heat insulating member 46 and the inner wall surface (inner wall surface 494, inner peripheral wall surface 292 and peripheral wall surface 341) of the rear housing member 13, there occur no clearances, there is no possibility that the refrigerant gas enters between the heat insulating member 44 and the inner wall surface (inner wall surface 494, inner peripheral wall surface 292 and peripheral wall surface 341) of the rear housing member 13. Therefore, heat in a portion of the inner wall surface (inner wall surface 494, inner peripheral wall surface 292 and peripheral wall surface 341) of the rear housing member 13 to be covered with the heat insulating member 44 is not directly transferred to the refrigerant gas. Hence, the adiabatic efficiency in the discharge chamber 28 and the discharge passage 34 is at least high to the same extent as in the third embodiment of FIG. 7.

In a fifth embodiment of FIG. 9, the heat insulating member 44 is urged toward the valve plate 14 by means of the seal ring 50 for surrounding the passage heat insulating member 442 and a plurality of coned disk springs 45 (only one is shown in the figure). The heat insulating member 46 is urged toward the valve plate 14 by means of a seal ring 51A for surrounding and fitting to the passage heat insulating member 462 and a plurality of coned disk springs 47 (only one is shown in the figure).

The fifth embodiment has respective advantages of the first embodiment of FIGS. 1 to 5, and the second embodiment of FIG. 6.

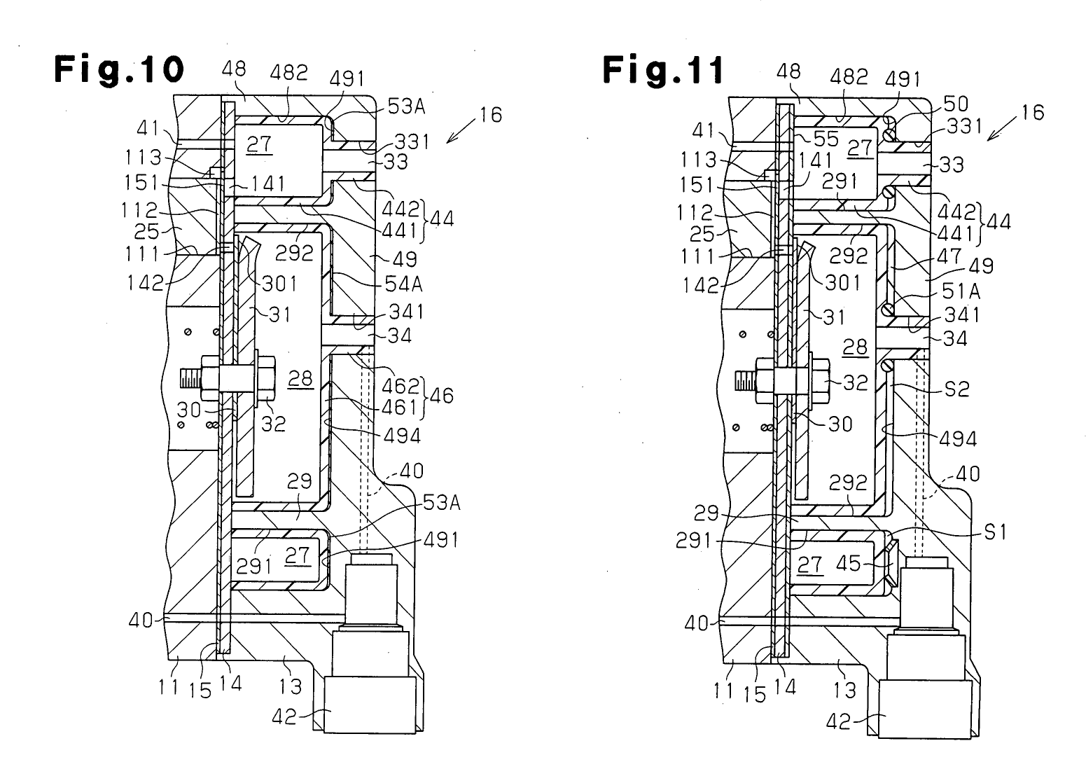

In the sixth embodiment of FIG. 10, the chamber heat insulating member 441 has been glued to the inner wall surface 491 of the end wall 49 by a glue layer 53A, and the chamber heat insulating member 461 has been glued to the inner wall surface 494 of the end wall 49 by a glue layer 54A. The glue layer 53A is a gluing member for restraining the refrigerant gas from flowing between the heat insulating member 44 and the inner wall surface (inner wall surface 482, 491, outer peripheral wall surface 291 and peripheral wall surface 331) of the rear housing member 13 by gluing the heat insulating member 44 to the inner wall surface (inner wall surface 491) of the rear housing member 13. The glue layer 54A is a gluing member for restraining the refrigerant gas from flowing between the heat insulating member 46 and the inner wall surface (inner wall surface 494, inner peripheral wall surface 292 and peripheral wall surface 341) of the rear housing member 13 by gluing the heat insulating member 46 to the inner wall surface 494 of the rear housing member 13.

The glue layer 53A reliably cuts off a gas flow reaching from the clearances between the passage heat insulating member 442 and the peripheral wall surface 331 of the suction passage 33 to the clearances between the chamber heat insulating member 441 and the inner wall surface 482 of the outer peripheral wall 48, and the clearances between the chamber heat insulating member 441 and the outer peripheral wall surface 291 of the partition wall 29. Therefore, the existence of the glue layer 53A contributes to the improved adiabatic efficiency in the suction chamber 27 and the suction passage 33. The glue layer 54A reliably obstructs a gas flow reaching from the clearances between the chamber heat insulating member 461 and the inner peripheral wall surface 292 of the partition wall 29 to the clearances between the passage heat insulating member 462 and the peripheral wall surface 341 of the discharge passage 34. Therefore, the existence of the glue layer 54A contributes to the improved adiabatic efficiency in the discharge pressure domain.

The glue layer 53A is provided only on the inner wall surface 491 of the end wall 49, and the glue layer 54A is provided only on the inner wall surface 494 of the end wall 49. In other words, only one portion of the heat insulating member 44, 46 is glued on the inner wall surface of the rear housing member 13. Therefore, as compared with a case where the entire surface of the heat insulating member 44, 46 has been glued to the inner wall surface of the rear housing member 13, there is not much possibility of the tensile load exerting on the heat insulating member 44, 46 because of a difference in the coefficient of thermal expansion. Hence, the heat insulating member 44, 46 has excellent durability.

The seventh embodiment of FIG. 11 is only different from the fifth embodiment of FIG. 9 in that on a surface of the valve plate 14, which faces the rear housing member 13, there is provided a rubber layer 55. The heat insulating member 44, 46 is pressed against the rubber layer 55. The rubber layer 55 restrains heat transfer to the refrigerant gas within the suction chamber 27 and within the discharge chamber 28 from the valve plate 14. The rubber layer 55 is separate from the valve plate 14 and the heat insulating member 44, 46. The rubber layer 55 is a coating member made of heat insulating material for covering the surface 143 of the valve plate 14, which faces the rear housing member 13 (cover housing).

The seventh embodiment has respective advantages of the third embodiment of FIG. 7, and the fifth embodiment of FIG. 9.

The invention may be embodied in the following forms.

(1) In a state in which the heat insulating member 44 has been inserted into the suction chamber 27 before installing the rear housing member 13 to the cylinder 11, the heat insulating member 44 may be formed such that the end edge 443, 444 of the heat insulating member 44 slightly protrudes from the suction chamber 27. In this case, with the rear housing member 13 installed to the cylinder 11, the heat insulating member 44 made of synthetic resin is strongly sandwiched between the valve plate 14 and the rear housing member 13, and elastically deforms so that the end edge 443, 444 is pressed against the valve plate 14. In the present embodiment, the heat insulating member 44 itself functions as a pressing-against member for pressing the heat insulating member 44 against a defining wall surface (surface 143 of the valve plate 14) of the suction chamber 27 by the elastic force.

In other words, the heat insulating member 44, 46 has elasticity and is held between the inner wall surface and the defining wall surface 143 to be elastically deformed such that the heat insulating member 44, 46 itself functions as the flow restraining member, respectively.

Similarly, in a state in which the heat insulating member 46 has been inserted into the discharge chamber 28 before installing the rear housing member 13 to the cylinder 11, the heat insulating member 46 may be formed such that the end edge 463 of the heat insulating member 46 slightly protrudes from the discharge chamber 28. In this case, with the rear housing member 13 installed to the cylinder 11, the heat insulating member 46 made of synthetic resin is strongly sandwiched between the valve plate 14 and the rear housing member 13, and elastically deforms so that the end edge 463 is pressed against the valve plate 14. In the present embodiment, the heat insulating member 46 itself functions as a pressing-against member for pressing the heat insulating member 46 against a defining wall surface (surface 143 of the valve plate 14) of the discharge chamber 28 by the elastic force.

(2) The end edge 443, 444, 463 of the heat insulating member 44, 46 may be provided with a rubber layer.

(3) The heat insulating member may be inserted into only the suction chamber 27.

(4) The heat insulating member may be inserted into only the discharge chamber 28.

(5) Only the inner wall surface (inner wall surface 482, 491 and outer peripheral wall surface 291) on the suction chamber 27 side in the rear housing member 13 may be covered with the heat insulating member. In other words, only one part of the inner wall surface for defining the suction chamber 27 may be covered with heat insulating member.

(6) For the material of the heat insulating member 44, 46, hard rubber or ceramic may be used.

(7) To a piston type compressor in which on the outer periphery side of the rear housing member 13, there is provided the discharge chamber and the suction chamber is surrounded by the discharge chamber around the axis line 181 of the rotating shaft 18, the present invention may be applied.

(8) In the sixth embodiment of FIG. 10, it may be possible to make the glue layer 53A, 54A of resin, and to press the heat insulating member 44, 46 against the valve plate 14 by the elastic force of the glue layer 53A, 54A made of resin. In other words, the glue layer 53A, 54A has elasticity and glues the heat insulating member 44, 46 to the inner wall surface 491, 494 that faces the defining wall surface 143, respectively.

(9) In place of the coned disk spring 45, 47, a compression type coil spring may be used.

(10) To any other compressor than the piston type compressor, the present invention may be applied.

(11) To any fixed displacement compressor, the present invention may be applied.

(12) To any compressor using any other refrigerant than carbon dioxide, the present invention may be applied.

The present examples and embodiments are to be considered as illustrative and not restrictive and the invention is not to be limited to the details given herein, but may be modified within the scope and equivalence of the appended claims.

1. A compressor that has a suction chamber and a discharge chamber, and compresses refrigerant gas, comprising:
a cover housing having an inner wall surface, the inner wall surface defining at least one of the suction chamber and the discharge chamber;
a heat insulating member that covers the inner wall surface; and
a flow restraining member that restrains refrigerant gas from flowing between the heat insulating member and the inner wall surface.

2. The compressor according to claim 1, further comprising a defining wall surface that, together with the inner wall surface, defines at least one of the suction chamber and the discharge chamber, wherein the flow restraining member presses the heat insulating member against the defining wall surface.

3. The compressor according to claim 1, further comprising a defining wall surface that, together with the inner wall surface, defines at least one of the suction chamber and the discharge chamber, wherein the defining wall surface is covered with a coating member, and the flow restraining member presses the heat insulating member against the coating member.

4. The compressor according to claim 2, wherein the heat insulating member has elasticity and is held between the inner wall surface and the defining wall surface to be elastically deformed such that the heat insulating member itself functions as the flow restraining member.

5. The compressor according to claim 1, wherein the flow restraining member is a sealing member located between the heat insulating member and the inner wall surface.

6. The compressor according to claim 1, wherein the flow restraining member is a glue layer that glues the heat insulating member to the inner wall surface.

7. The compressor according to claim 6, further comprising a defining wall surface that, together with the inner wall surface, defines at least one of the suction chamber and the discharge chamber, wherein the glue layer has elasticity and glues the heat insulating member to a section of the inner wall surface that faces the defining wall surface, wherein the glue layer presses the heat insulating member against the defining wall surface.

8. The compressor according to claim 1, wherein the cover housing has the discharge chamber and the suction chamber, the compressor further comprising:
a cylinder block coupled to the cover housing, wherein the cylinder block has a cylinder bore;
a rotating shaft; and
a piston that is accommodated in the cylinder bore and defines a compression chamber in the cylinder bore, wherein the piston reciprocates in the cylinder bore based on rotation of the rotating shaft.

9. The compressor according to claim 1, wherein the cover housing has the discharge chamber and the suction chamber, the compressor further comprising:
a cylinder block coupled to the cover housing, wherein the cylinder block has a cylinder bore;
a rotating shaft;
a piston that is accommodated in the cylinder bore and defines a compression chamber in the cylinder bore, wherein the piston reciprocates in the cylinder bore based on rotation of the rotating shaft; and
a valve plate located between the cover housing and the cylinder block, the valve plate separating the compression chamber from the suction chamber and the discharge chamber,
wherein the flow restraining member presses the heat insulating member against the valve plate.

10. The compressor according to claim 1, wherein the cover housing has the discharge chamber and the suction chamber, the compressor further comprising:
a cylinder block coupled to the cover housing, wherein the cylinder block has a cylinder bore;
a rotating shaft;
a piston that is accommodated in the cylinder bore and defines a compression chamber in the cylinder bore, wherein the piston reciprocates in the cylinder bore based on rotation of the rotating shaft;
a valve plate located between the cover housing and the cylinder block, the valve plate separating the compression chamber from the suction chamber and the discharge chamber, and
a coating member that coats a surface of the valve plate that faces the cover housing,
wherein the coating member has heat insulating properties, and the coating member is formed separately from the valve plate and the heat insulating member, and wherein the fluid restraining member presses the heat insulating member against the coating member.

11. The compressor according to claim 10, wherein the coating member is a gasket.

12. The compressor according to claim 1, wherein the heat insulating member is loosely inserted in at least one of the suction chamber and the discharge chamber.

13. The compressor according to claim 1, further comprising:
a compression chamber;
a valve plate that separates the compression chamber from the suction chamber and the discharge chamber;
a suction passage for introducing refrigerant gas from the outside of the compressor into the suction chamber; and
a discharge passage for discharging refrigerant gas from the discharge chamber to the outside of the compressor,
wherein the heat insulating member is loosely inserted in at least one of the suction chamber and the discharge chamber so that a clearance is created between the inner wall surface and the heat insulating member, the clearance expanding to the valve plate from either one of the suction passage and the discharge passage, and wherein the flow restraining member blocks the clearance between the valve plate and either one of the suction passage and the discharge passage.

14. The compressor according to claim 13, wherein the flow restraining member defines a blockaded space between the heat insulating member and the inner wall surface.

15. The compressor according to claim 13, wherein the suction chamber is provided around the discharge chamber.

16. The compressor according to claim 1, wherein the refrigerant gas is carbon dioxide.

17. A piston type compressor that has a suction chamber and a discharge chamber, and compresses refrigerant gas, comprising:
a cover housing having an inner wall surface, the inner wall surface defining at least one of the suction chamber and the discharge chamber;
a cylinder block coupled to the cover housing, wherein the cylinder block has a cylinder bore;
a rotating shaft;
a piston that is accommodated in the cylinder bore and defines a compression chamber in the cylinder bore, wherein the piston reciprocates in the cylinder bore based on rotation of the rotating shaft;
a valve plate located between the cover housing and the cylinder block, the valve plate separating the compression chamber from the suction chamber and the discharge chamber;
a heat insulating member that covers the inner wall surface; and
an elastic member, wherein the elastic member presses the heat insulating member against a valve plate or against a coating member that coats a surface of the valve plate that faces the cover housing.

18. A piston type compressor that has a suction chamber and a discharge chamber, and compresses refrigerant gas, comprising:
a cover housing having an inner wall surface, the inner wall surface defining at least one of the suction chamber and the discharge chamber;
a cylinder block coupled to the cover housing, wherein the cylinder block has a cylinder bore;
a rotating shaft;
a piston that is accommodated in the cylinder bore and defines a compression chamber in the cylinder bore, wherein the piston reciprocates in the cylinder bore based on rotation of the rotating shaft;
a valve plate located between the cover housing and the cylinder block, the valve plate separating the compression chamber from the suction chamber and the discharge chamber;
a heat insulating member that covers the inner wall surface; and
a glue layer that glues the heat insulating member to the inner wall surface.
